(19) United States
(12) Patent Application Publication
(10) Pub. No.: US 2026/0336503 A1
(43) Pub. Date: Oct. 29, 2026

(54) RATCHET BUCKLE

(71) Applicant: Tim Tucker, Auburn, NY (US)

(72) Inventor: Tim Tucker, Auburn, NY (US)

(21) Appl. No.: 19/393,737

(22) Filed: Nov. 19, 2025

Related U.S. Application Data
(60) Provisional application No. 63/752,166, filed on Jan. 31, 2025.

(51) Int. Cl. B60P 7/08

(52) U.S. Cl. CPC B60P 7/083

(57) ABSTRACT

The present invention is a tie-down ratcheting buckle comprising; a lever arm; a housing plate having a set of slots; a locking plate have two extensions, wherein the extensions extend through the set of slots on the housing plate; an frame; a spacer having a plurality of slots extending through the spacer; a first locking arm having a first end with a set of teeth; a second locking arm having a first end with a set of teeth; a first rod passing through the housing plate, the lever arm, and the frame; a second rod passing through the housing plate, the frame, one of the slots of the spacer, the first locking arm, and the second locking arm; and a spring interfacing with the locking plate and the spacer.

### CROSS-REFERENCE TO RELATED APPLICATIONS

This application is a continuation-in-part (and claims the benefit of priority under 35 USC 120) of U.S. provisional application No. 63/752,166 Filed Jan. 1, 2025. The disclosure of the prior applications is considered part of (and is incorporated by reference in) the disclosure of this application.

### BACKGROUND OF THE INVENTION

The present invention relates to a ratchet buckle used for tightening straps to secure cargo, and more particularly to a light weight ratchet device with a quick release mechanism.

In general, ratchet mechanisms for cargo storage and other general uses, having ratchet drive wheels and spring-loaded ratchet drive plate mechanisms are well known. Such ratchet buckles are commonly used to assist in securing cargo straps for transport or storage of cargo. Ratchet buckles generally consist of a ratcheting mechanism and a mechanism for receiving, securing and tightening a strap to be used for securing cargo. To operate such a buckle a cargo strap is coupled to the buckle and tightened using the ratcheting feature. Current ratchet buckles contain many heavy metallic parts which lead to high weight and bulk.

However, these devices are typically either difficult to use due to their complicated setups and design, or they are difficult to tighten the straps due to excessive friction within the mechanism.

It would be desired for a ratchet buckle to have a simple design, an easy to engage and disengage locking mechanism, and obviate the disadvantages of the conventional ratchet buckle.

### SUMMARY

In a first embodiment, the present invention is a tie-down ratcheting buckle comprising: a lever arm having a set of apertures; a housing plate having a first set of apertures, a second set of apertures and a set of slots; a locking plate have two extensions, wherein the extensions extend through the set of slots on the housing plate; a frame having a first set of apertures and a second set of apertures; a cam having a plurality of slots extending through the cam; a first locking arm having a first end with a set of teeth and a first aperture and a second end having a second aperture and interfacing with the housing plate; a second locking arm having a first end with a set of teeth and a first aperture and a second end having a second aperture, wherein the first aperture of the first locking arm and the first aperture of the second locking arm are substantially aligned and the second locking arm interfacing with the housing plate; a first rod passing through the first set of apertures of the housing plate, the set of apertures of the lever arm, and the first set of apertures of the frame; a second rod passing through the second set of apertures of the housing plate, the second set of apertures of the frame, one of the slots of the cam, and the first aperture of the first locking arm and the first aperture of the second locking arm; and a spring interfacing with the locking plate and the cam.

In a second embodiment, the present invention is a tie-down ratcheting buckle comprising: a lever arm having a set of apertures; a housing plate having a first set of apertures, a second set of apertures and a set of slots, wherein the first set of apertures align with the set of apertures of the lever arm; a locking plate have two extensions, wherein the extensions extend through the set of slots on the housing plate; a frame having a first set of apertures, a second set of apertures, a cavity, and a channel wherein the locking plate fits within the channel; a cam positioned within the cavity of the frame; a first locking arm having a first end with a set of teeth and a first aperture and a second end having a second aperture, wherein the first aperture aligns with the second set of apertures of the frame; a second locking arm having a first end with a set of teeth and a first aperture and a second end having a second aperture, wherein the first aperture aligns with the second set of apertures of the frame and the first aperture of the first locking arm and the first aperture of the second locking arm are aligned; a first rod passing through the first set of apertures of the housing plate, the set of apertures of the lever arm, and the first set of apertures of the frame; a second rod passing through the second set of apertures of the housing plate, the second set of apertures of the frame, the cam, and the first aperture of the first locking arm and the first aperture of the second locking arm; and a spring interfacing with the locking plate and the cam.

In a third embodiment, the present invention is a tie-down ratcheting buckle comprising: a frame having a first set of apertures, a second set of apertures, a cavity, and a channel; a cam inserted into the cavity; a locking plate have two extensions and positioned within the channel of the frame; a lever arm having a set of apertures interfacing with the frame; a housing plate having a first set of apertures, a second set of apertures and a set of slots, wherein the housing plate interfaces with the lever arm; a first locking arm having a first end with a set of teeth and a first aperture and a second end having a second aperture, wherein the first locking arm interfaces with the housing plate; a second locking arm having a first end with a set of teeth and a first aperture and a second end having a second aperture, wherein the second locking arm interfaces with the housing plate; a first rod passing through the first set of apertures of the housing plate, the set of apertures of the lever arm, and the first set of apertures of the frame; a second rod passing through the second set of apertures of the housing plate, the second set of apertures of the frame, the cam, and the first aperture of the first locking arm and the first aperture of the second locking arm; and a spring interfacing with the locking plate.

### BRIEF DESCRIPTION OF THE DRAWINGS

FIG. 1 depicts an illustration of a tie-down strap buckle, in accordance with one embodiment of the present invention.

FIG. 2 depicts an illustration of the tie-down strap buckle in an exploded view, in accordance with one embodiment of the present invention.

FIG. 3 depicts an illustration of a lever arm, in accordance with one embodiment of the present invention.

FIG. 4 depicts an illustration of a housing plate, in accordance with one embodiment of the present invention.

FIG. 5 depicts an illustration of a locking plate, in accordance with one embodiment of the present invention.

FIG. 6A depicts an illustration of a frame, in accordance with one embodiment of the present invention.

FIG. 6B depicts an illustration of the frame, in accordance with one embodiment of the present invention.

FIG. 6C depicts an illustration of the frame, in accordance with one embodiment of the present invention.

FIG. 7A depicts an illustration of a cam, in accordance with one embodiment of the present invention.

FIG. 7B depicts an illustration of the cam, in accordance with one embodiment of the present invention.

FIG. 8 depicts an illustration of a locking arm, in accordance with one embodiment of the present invention.

FIG. 9 depicts an illustration of a locking arm, in accordance with one embodiment of the present invention.

FIG. 10 depicts an illustration of a spacer, in accordance with one embodiment of the present invention.

FIG. 11 depicts an illustration of the tie-down strap buckle in a first position, in accordance with one embodiment of the present invention.

FIG. 12 depicts an illustration of the tie-down strap buckle in a second position, in accordance with one embodiment of the present invention.

FIG. 13 depicts a section illustration of the tie-down strap buckle, in accordance with one embodiment of the present invention.

FIG. 14 depicts a section illustration of the tie-down strap buckle, in accordance with one embodiment of the present invention.

FIG. 15 depicts an illustration of internal components of the tie-down strap buckle, in accordance with one embodiment of the present invention.

### DETAILED DESCRIPTION OF THE INVENTION

The present invention provides a device that allows for the ability to quickly and easily secure a strap around a payload with a safe and secure locking mechanism. The locking mechanism provides for a multi-point locking system that also has a visual indicator of the lock being full engaged. The lock is also easy to disengage when ready to unload the payload.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. It is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements or use of a “negative” limitation.

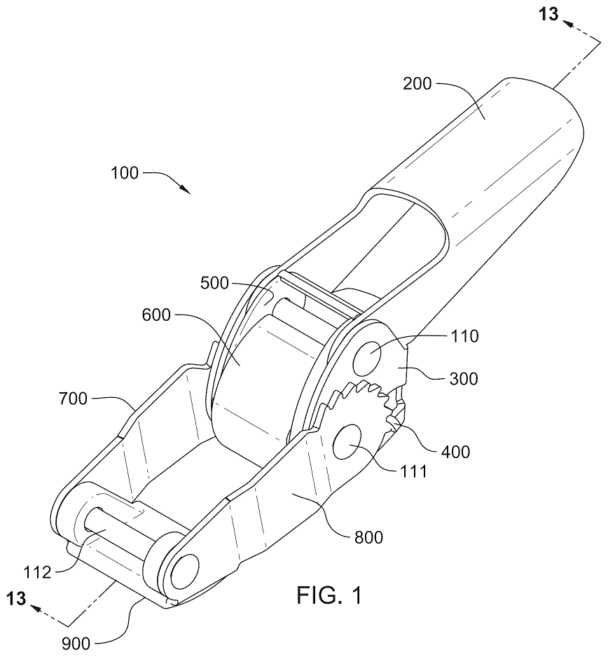

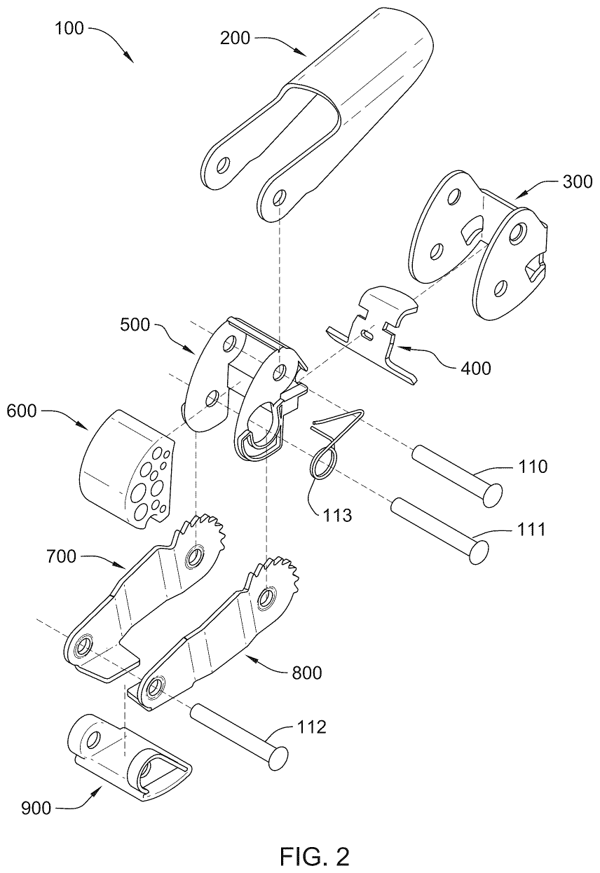

FIGS. 1-2 depict illustrations of a tie-down strap buckle 100, in accordance with one embodiment of the present invention. The present invention provides an advantage of allowing a user to quickly secure the payload with minimal work required and to easily disengage the tie-down strap buckle 100 with minimal work while also providing a visual indicator that the payload is secured. Through the novel locking method, shaking, bumps, or movement, the tie-down strap buckle 100 will not be affected.

The tie-down strap buckle 100 connects a first strap 101 and a second strap 102. tie-down strap buckle 100 is comprised of a lever arm 200, a housing plate 300, a locking plate 400, a frame 500, spacer 600, locking arms 700 and 800, and spacer 900.

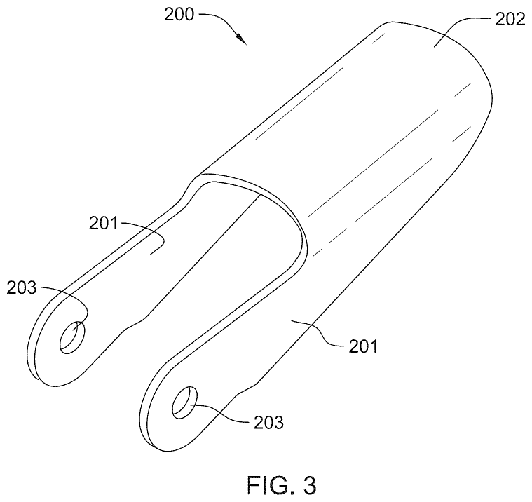

The lever arm 200 as shown in FIG. 3 is used to ratchet the tie-down strap buckle 100 down on the payload and provide a leveraged arm for the user. The lever arm 200 is a single piece of material with two arms 201 extending from the main body 202. Each of the arms 201 are of substantially the same length with an aperture 202 placed at the end of the arm 201.

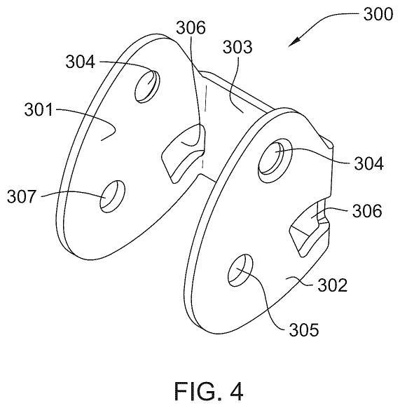

The housing plate 300, as shown in FIG. 4 provides structural support for the locking mechanism and the overall strength of the tie-down strap buckle 100. The housing plate 300 is a single piece of material with two arms 301 and 302 extending from a central plate 303. The arms 301 and 302 are substantially the same size and shape. Each arm 301 and 302 has a countersink aperture 304, an aperture (307 and 305 respectively), and a slot 306. The countersunk apertures 304 are substantially aligned, the slots 306 are substantially aligned, and apertures 307 and 305 are substantially aligned so that they are able to receive a rod or shaft inserted through them. The apertures and slots are positioned relative to the frame 500 and locking plate 400 design.

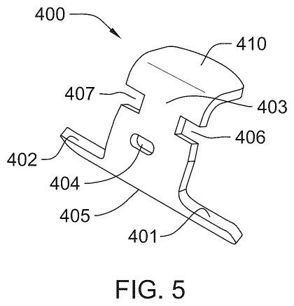

The locking plate 400, as shown in FIG. 5, provides for a portion of the locking device integrated into the tie-down strap buckle 100. The locking plate 400 is a single piece of material with two extensions 401 and 402 extending from a lower end 405 of a main body portion 403. The main body portion 403 is bent at predetermined lengths from the lower end 405 and at predetermined angles. A center opening 404 in the locking plate provides an opening for the spring 113 to interface with the locking plate for the engaging and disengaging of the tie-down strap buckle 100.

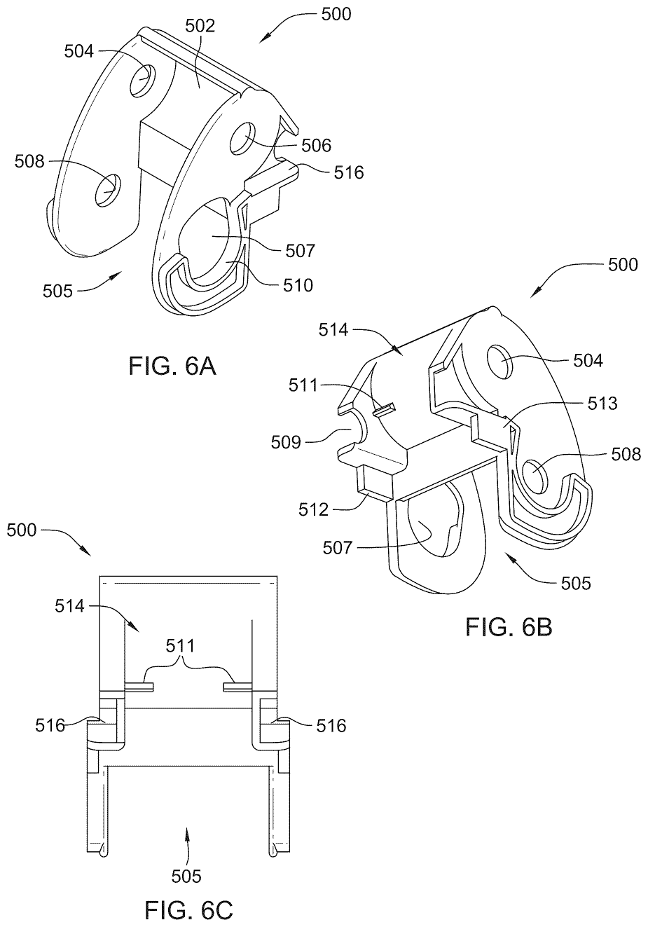

The frame 500 as depicted in FIGS. 6A, 6B, and 6C, provides for the internal structure for which the strap 102 passes through the tie-down strap buckle 100. The frame 500 is a single piece of material. The frame 500 is a two walled member, where the sides form a main center cavity 505 sized to fit the space 600, and a secondary cavity 502 that provides the space for the strap 102 to pass through and around rod 110. The frame 500 has two sides, a first side an aperture 504 and aperture 508 where aperture 504 is positioned relative to cavity 502 and aperture 508 is positioned relative to main center cavity 505 505. A second side with apertures 506 and 507 where aperture 506 is positioned relative to aperture 504 and aperture 507 is positioned relative to aperture 508. Aperture 507 is enlarged to accommodate spring 113. On an exterior side of the second side, a ledge 510 is present to support spring 113. Platforms 516 assists in keeping the locking plate 400 from sliding off center. Extensions 512 and 513 provide structural support for the frame and also provide a resting place for extensions 402 and 401 when the locking plate 400 is disengaged. Slot 509 provides an opening for spring 113 to pass through when interfacing the locking plate 400. Tab 511 positions locking plate 400 at the correct angle as it interacts with teeth 704 and 804. Tab 511 also provides for a resting place for the locking plate 400 when the locking plate 400 is disengaged. Tab 511 interacts with slots 406 and 407. As shown in FIG. 6C there are two tabs 511 on each side of channel 514. When in the disengaged position, extensions 512 and 513 hold extensions 401 and 402 out of the way of teeth 704 and 804. With this, the operator is not forced to continually lift locking bar 400 while housing 300 is being rotated back.

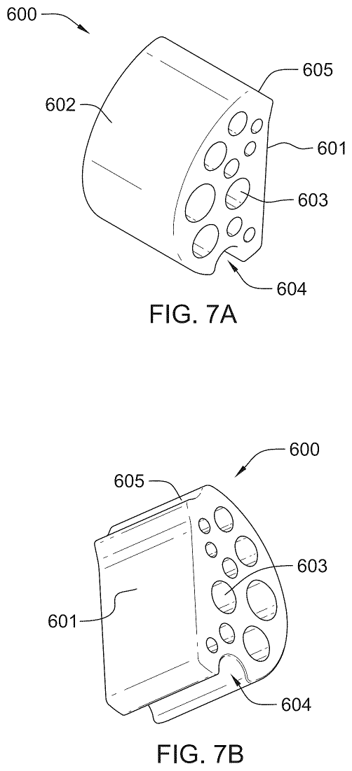

The cam 600 as shown in FIGS. 7A and 7B, provides for a surface for the strap 102 to interface with. The cam 600 has a flat face 601 and a curved face 602. A slot 604 is used for the operator to adjust the position of the cam 600 when inserting the strap 102 through the tie-down strap buckle 100. Slot 605 is sized to receive the rod 110, so that rod 110 can interface with the cam 600 when engaged. The cam 600 has a series of apertures 603, wherein each of the apertures 603 are sized to at least fit a rods 110 and 111, some of the apertures 603 are to reduce the weight of the cam 600 without losing structural integrity.

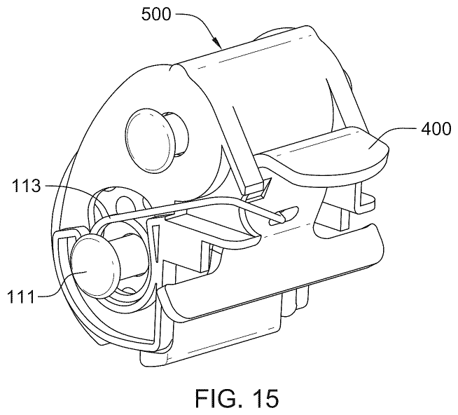

FIG. 15 depicts a sub assembly of the frame 500, the cam 600, the locking plate 400, spring 113, and rods 110 and 111. As shown, the locking plate 400 fits within the channel 514 of the frame 500 and the spring 113 pressing against the locking plate 400 and passes through opening 404 to keep the spring 113 engaged with the locking plate 400. The spring 113 keeps the locking plate 400 in a first position, so that the locking plate 400 does not move and disengage the tie-down strap buckle 100. The spring 113 is held in position by the rod 110 and a portion of the spring 113 is inserted through one of the openings 603 of the cam 600.

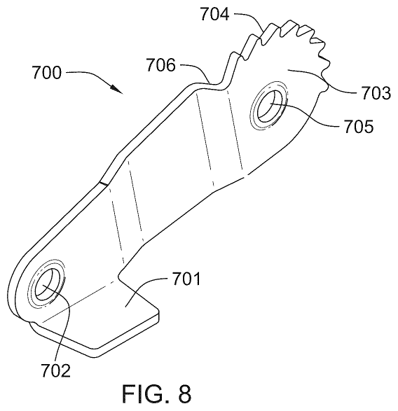

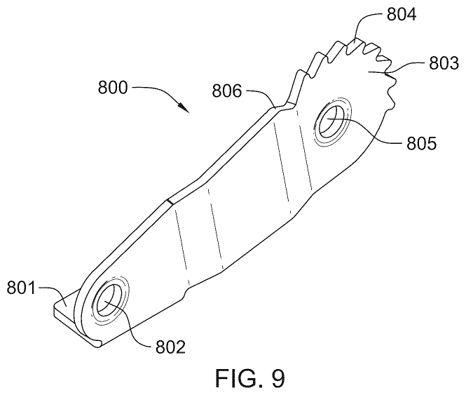

The locking arms 700 and 800 are shown in FIG. 8 and FIG. 9 respectively, providing the second portion of the locking mechanism for the tie-down strap buckle 100. The locking arms 700 and 800 are substantially similar in design. Each arm has a tab 701 and 801 which extends towards a center axes on a first end. An aperture 702 and 802 are positioned related to the respective tab 701 or 801. At a second end of the locking arms is a circular section 703 and 803 that have a series of teeth 704 and 804 that are sized and positioned to interface with the extensions 401 and 402 of the locking plate. At the second end of the locking arms is an aperture 705 and 805 respectively. There are a predetermined number of teeth on each locking arm that start at a predetermined location as well. Encircling apertures 705 and 805 are detents the act as spacers to reduce the amount of friction that would otherwise be produced by the full surfaces of 700 and 800 against housing 300. Indent 706 and 806 provide for the advantage of allowing the release of extensions 401 and 402 from tab 511. As house 300 rotates to its furthest point during the disengage mode, indents 706 and 806 press upon extensions 401 and 402 in such a way as to release locking plate 400 from tab 511. The indents 706 and 806 prevent the user from having to release the locking plate 400.

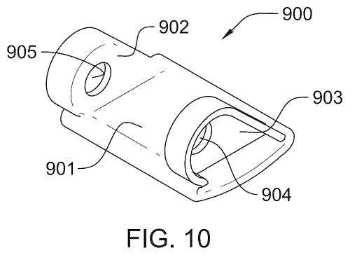

The spacer 900 as shown in FIG. 10, provides structural support for the locking arms 700 and 800. The spacer has a main body portion 901 with two extensions 902 and 903. The extensions have an apertures 904 and 905 respectively. The spacer 900 is sized to fit between the locking arms 700 and 800 and the tabs 701 and 801 fit within the extensions 902 and 903 respectively.

To secure various members together, rods 110, 111, and 112 are used. These rods 110, 111, and 112 may be threaded or may secured in place by other locking mechanisms or designs. In additional embodiments, the rods 110, 111, and 112 are rivets. In additional embodiments rods 110, 111, and 112 are threaded and a locking nut (not shown) is used to secure the rods to the tie-down strap buckle 100.

A spring 113 is used to apply pressure to the locking mechanism, keeping the locking mechanism (the locking plate 400) in the locked position so that the tie-down strap buckle 100 does not become unintentionally loosened or disconnected. The locking mechanism is designed so that it remains engaged and in the locked position unless a user applies pressure to the locking plate 400 and disengages the locking mechanism. The spring 113 has a predetermined shape, size, and K-value based on the overall design of the tie-down strap buckle 100.

When assembled rod 110 passes through housing plate 300 aperture 304, lever arm 200 aperture 202, frame aperture 506,, frame 500 apertures 504, lever arm 200 aperture 203, housing plate 300 aperture 304, and interfaces with the strap 102 that is positioned between rod 110 and surface 605 of the cam 600.

When assembled rod 111 passes through locking arm 800 aperture 805, housing plate aperture 305, frame 500 aperture 507, cam 600 aperture 603, main center cavity 505, housing plate 300 aperture 307, and locking arm 700 aperture 705.

When assembled rod 112 passes through locking arm 700 aperture 702, spacer 900 apertures 905 and 904, and locking arm 800 aperture 802, to secure the spacer 900 between the locking arms 700 and 800. In some embodiments, locking arms 700 and 800 are a single components and space 900 is removed.

As depicted in the assembly figures, the lever arm 200 is positioned between the housing plate 300 and the frame 500, with the cam 600 fit within the cavity 505 of the frame 500. The locking plate 400 is positioned between the housing plate 300 with extensions 402 and 401 extending through slots 306 and the frame 500. The housing plate 300 arms 301 and 302 are positioned between locking arms 700 and 800 and frame 500.

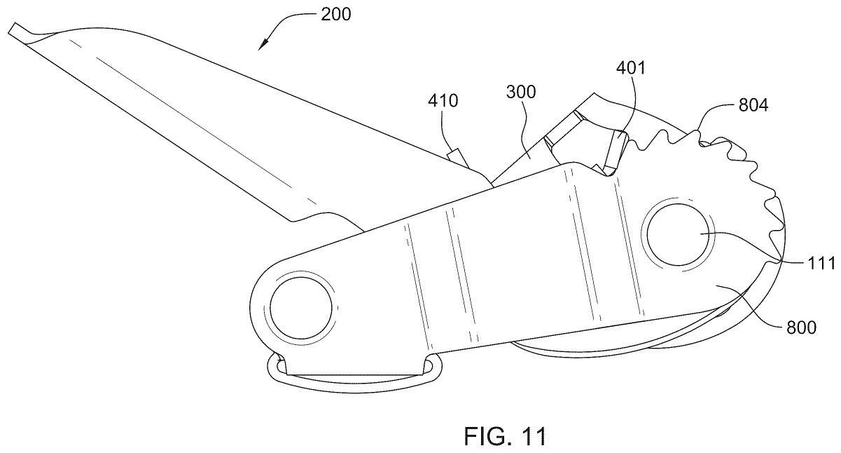

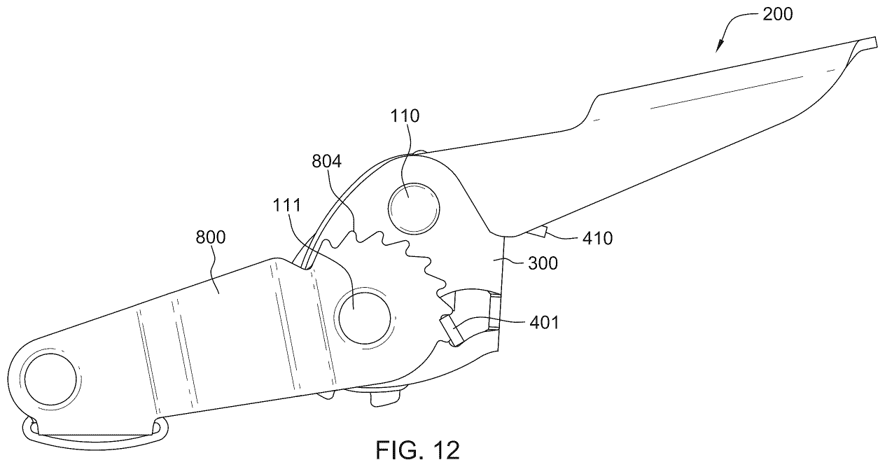

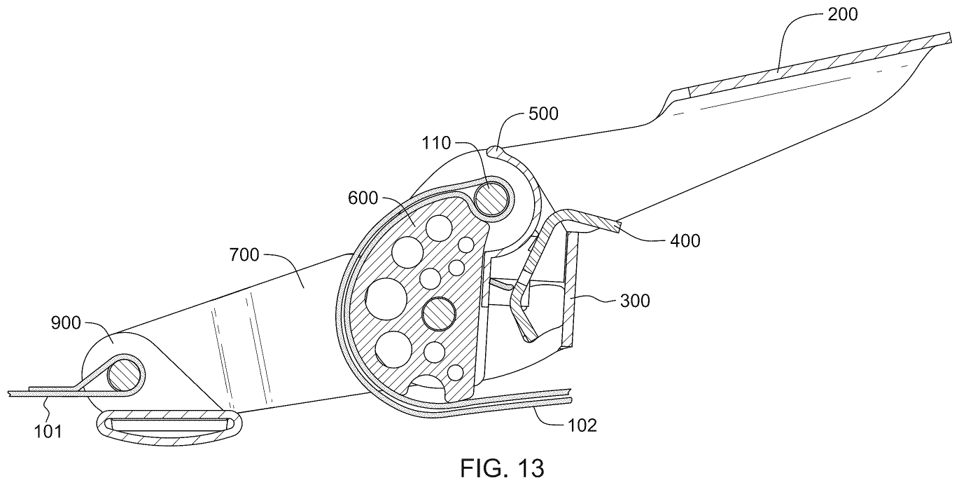

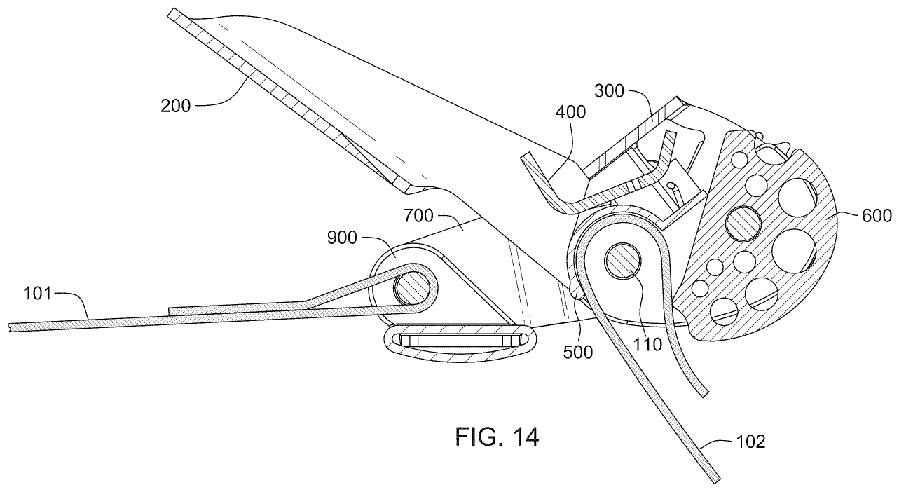

When fully assembled the tie-down strap buckle 100 is locked through the following operation as shown in FIGS. 11-14. To insert strap 102 through the tie-down strap buckle 100, the operator will rotate the lever 200 along with the housing plate 300 to the second position as shown in FIG. 11, and lift the locking plate 400 tab 410, then rotating the cam 600 using slot 604, so that the cam 600 is no longer in contact with rod 110 (FIG. 14). The strap 102 is then inserted over and around the rod 110 as shown in FIG. 13. The end of the strap 102 is then pulled until the strap 102 is taught around the payload. Once the strap 102 is in place, the operator pulls the lever 200 until the payload is sufficiently taught and secured. As the lever 200 is pulled to a first position (FIG. 12) teeth 804 of locking arm 800 engage with extension 401 of the locking plate 400 (while simultaneously the teeth 704 of locking arm 700 engage with extension 402 of locking plate 400 on the opposite side) to lock the tie-down strap buckle 100.

To release the tie-down strap buckle 100 the user presses downward on the lever 200 towards the strap 102 and lifts the tab 410 of the locking plate 400 and rotating the cam 600 and the housing plate 300 using slot 604 so that the cam 600 is not in contact with rod 110 and pulling the strap 102 through the tie-down strap buckle 100.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

It will be further understood that various changes in the details, materials, and arrangements of the parts which have been described and illustrated in order to explain the nature of this invention may be made by those skilled in the art without departing from the scope of the invention as expressed in the following claims.

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

The foregoing descriptions of various embodiments have been presented only for purposes of illustration and description. They are not intended to be exhaustive or to limit the present invention to the forms disclosed. Accordingly, many modifications and variations of the present invention are possible in light of the above teachings will be apparent to practitioners skilled in the art. Additionally, the above disclosure is not intended to limit the present invention. In the specification and claims the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g., attached, adhered, joined) are to be construed broadly and may include intermediate members between a connection of elements and relative movement between elements. As such, joinder references do not necessarily infer that two elements are directly connected and in fixed relation to each other. Moreover, network connection references are to be construed broadly and may include intermediate members or devices between network connections of elements. As such, network connection references do not necessarily infer that two elements are in direct communication with each other. In some instances, in methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to the embodiments outlined above, various alternatives, modifications, variations, improvements and/or substantial equivalents, whether known or that are or may be presently foreseen, may become apparent to those having at least ordinary skill in the art. Listing the steps of a method in a certain order does not constitute any limitation on the order of the steps of the method. Accordingly, the embodiments of the invention set forth above are intended to be illustrative, not limiting. Persons skilled in the art will recognize that changes may be made in form and detail without departing from the spirit and scope of the invention. Therefore, the invention is intended to embrace all known or earlier developed alternatives, modifications, variations, improvements and/or substantial equivalents.

What is claimed is:

1. A tie-down ratcheting buckle comprising:
a lever arm having a set of apertures;
a housing plate having a first set of apertures, a second set of apertures and a set of slots;
a locking plate have two extensions, wherein the extensions extend through the set of slots on the housing plate;
a frame having a first set of apertures and a second set of apertures;
a cam having a plurality of slots extending through the cam;
a first locking arm having a first end with a set of teeth and a first aperture and a second end having a second aperture and interfacing with the housing plate;
a second locking arm having a first end with a set of teeth and a first aperture and a second end having a second aperture, wherein the first aperture of the first locking arm and the first aperture of the second locking arm are substantially aligned and the second locking arm interfacing with the housing plate;
a first rod passing through the first set of apertures of the housing plate, the set of apertures of the lever arm, and the first set of apertures of the frame;
a second rod passing through the second set of apertures of the housing plate, the second set of apertures of the frame, one of the slots of the cam, and the first aperture of the first locking arm and the first aperture of the second locking arm; and
a spring interfacing with the locking plate and the cam.

2. The tie-down ratcheting buckle of claim 1, further comprising, a spacer positioned between the first and second locking arms.

3. The tie-down ratcheting buckle of claim 2, further comprising a third rod passing through the second aperture of the first locking arm, the second apertures of the second locking arm, and the spacer.

4. The tie-down ratcheting buckle of claim 1, wherein the first and second locking arms have tab extending from the locking arms distal to the second apertures.

5. The tie-down ratcheting buckle of claim 1, wherein the two extensions of the locking plate extend to pass through the slots of the housing plate and interface with the teeth of the first and second locking arms.

6. The tie-down ratcheting buckle of claim 1, wherein the frame has a cavity sized to receive the cam.

7. The tie-down ratcheting buckle of claim 3, further comprising, a first and a second strap, wherein the first strap is engaged with the third rod and the second strap is engaged with the first rod.

8. The tie-down ratcheting buckle of claim 1, wherein the cam has a carve out positioned relative to the first rod.

9. The tie-down ratcheting buckle of claim 1, wherein the first and second locking arm have the same positioning and number of teeth.

10. The tie-down ratcheting buckle of claim 1, wherein the cam is able to rotate about the second rod.

11. A tie-down ratcheting buckle comprising:
a lever arm having a set of apertures;
a housing plate having a first set of apertures, a second set of apertures and a set of slots, wherein the first set of apertures align with the set of apertures of the lever arm;
a locking plate have two extensions, wherein the extensions extend through the set of slots on the housing plate;
a frame having a first set of apertures, a second set of apertures, a cavity, and a channel wherein the locking plate fits within the channel;
a cam positioned within the cavity of the frame;
a first locking arm having a first end with a set of teeth and a first aperture and a second end having a second aperture, wherein the first aperture aligns with the second set of apertures of the frame;
a second locking arm having a first end with a set of teeth and a first aperture and a second end having a second aperture, wherein the first aperture aligns with the second set of apertures of the frame and the first aperture of the first locking arm and the first aperture of the second locking arm are aligned;
a first rod passing through the first set of apertures of the housing plate, the set of apertures of the lever arm, and the first set of apertures of the frame;
a second rod passing through the second set of apertures of the housing plate, the second set of apertures of the frame, the cam, and the first aperture of the first locking arm and the first aperture of the second locking arm; and
a spring interfacing with the locking plate and the cam.

12. The tie-down ratcheting buckle of claim 11, wherein the first locking arm and the second locking arm interface with the housing plate.

13. The tie-down ratcheting buckle of claim 11, wherein the housing plate is positioned between the frame and the first locking arm and the second locking arm.

14. The tie-down ratcheting buckle of claim 11, further comprising a strap which wraps around the first rod and interfaces with the cam.

15. The tie-down ratcheting buckle of claim 11, further comprising a space positioned relative to the second aperture of the first locking arm and the second aperture of the second locking arm.

16. The tie-down ratcheting buckle of claim 15, further comprising a third rod inserted through the second aperture of the first locking arm and the second aperture of the second locking arm.

17. The tie-down ratcheting buckle of claim 16, further comprising a second strap attached to the third rod.

18. The tie-down ratcheting buckle of claim 11, wherein the locking plate is able to translate from a first position to a second position.

19. A tie-down ratcheting buckle comprising:
a frame having a first set of apertures, a second set of apertures, a cavity, and a channel;
a cam inserted into the cavity;
a locking plate have two extensions and positioned within the channel of the frame;
a lever arm having a set of apertures interfacing with the frame;
a housing plate having a first set of apertures, a second set of apertures and a set of slots, wherein the housing plate interfaces with the lever arm;
a first locking arm having a first end with a set of teeth and a first aperture and a second end having a second aperture, wherein the first locking arm interfaces with the housing plate;
a second locking arm having a first end with a set of teeth and a first aperture and a second end having a second aperture, wherein the second locking arm interfaces with the housing plate;
a first rod passing through the first set of apertures of the housing plate, the set of apertures of the lever arm, and the first set of apertures of the frame;
a second rod passing through the second set of apertures of the housing plate, the second set of apertures of the frame, the cam, and the first aperture of the first locking arm and the first aperture of the second locking arm; and
a spring interfacing with the locking plate.

20. The tie-down ratcheting buckle of claim 19, wherein the extensions of the locking plate interface with the set of teeth of the first and second locking arm when the locking plate is in a first position.
